(19) United States
(12) Patent Application Publication
(10) Pub. No.: US 2007/0001147 A1
(43) Pub. Date: Jan. 4, 2007

(54) Method and apparatus for manumacturing liquid crystal display panels by one-drop fill of liquid crystal material

(75) Inventors: Takashi Kamino, Izumi-Shi (JP); Hiromitsu Tanaka, Izumi-Shi (JP); Daisuke Inoue, Kanagawa (JP); Hideki Ito, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/477,526

(22) Filed: Jun. 30, 2006

(30) Foreign Application Priority Data
Jul. 4, 2005 (JP) 2005-194538

(51) Int. Cl. C09K 19/34

(52) U.S. Cl. 252/299.61

(57) ABSTRACT

Spacer heights are measured at a plurality of measuring points on the display area in a substrate, and the distribution of spacer heights in the display area is estimated in accordance with the measured spacer heights. The average value of spacer heights are calculated by virtually dividing the display area into a plurality of sectors, and a dispensing amount in each sector is accurately controlled in accordance with the difference between the average value and a reference value.

### BACKGROUND OF THE INVENTION

1. Field of the Invention

The present invention relates to a method and an apparatus for manufacturing a liquid crystal display panel by a one drop fill process, and more particularly to a method and an apparatus for manufacturing a liquid crystal display panel having more uniform display characteristics.

2. Description of the Related Art

Liquid crystal display panels are widely used as a display unit of Audio and Visual (AV) equipment or Office Automation (OA) equipment because of their thinness, light weight and low power consumption. A typical liquid crystal display panel holds liquid crystal material between one substrate in which active switching devices such as TFTs (Thin Film Transistors) are formed in a matrix (hereafter referred to as an active matrix substrate) and another substrate in which a color filter (CF) and a black matrix (BM) are formed (hereafter referred to as a counter substrate). The liquid crystal display panel displays an image by controlling the director direction of liquid crystal molecules via an electric field between pixel electrodes and a counter electrode, and modulating the light transmitted through the liquid crystal display panel.

In the case of such liquid crystal display panels, it is important to control the cell gap between the active matrix substrate and the counter substrate. Therefore, spacers, such as column-shaped spacers or spherical spacers, are formed on at least one substrate. A liquid crystal dispensing apparatus is used in practice to drop an appropriate amount of liquid crystal material into the gap determined by the column-shaped spacer by measuring the height of the column-shaped spacer and controlling the amount of liquid crystal to be dropped in accordance with the measurement result. This process is known as the One Drop Fill (ODF) process.

For example, a first liquid crystal dispensing apparatus calculates automatically the target value for the amount of the liquid crystal material to be dispensed (hereafter referred to as the dispensing amount) in accordance with the difference between the measured column height of the column-shaped spacer and the column height of a reference column-shaped spacer, then determine the number of drops to be dispensed to a liquid crystal amount adjusting area (hereafter referred to as the number of dropping points), and thereby control the dispensing amount corresponding to the target value. Such a method is proposed in Japanese Patent Laid-Open No. 2003-295199.

A second liquid crystal dispensing apparatus controls the value of the dispensing amount calculated on measurements of the column height of a column-shaped spacer similarly to the first apparatus. Providing two dispensers for dropping a large drop of liquid crystal material and for dropping a small drop thereof, the number of the dropping points are increased or decreased in each of the dispensers, and the total amount of the liquid crystal material in the display area is thereby adjusted closely. Such a method is proposed in Japanese Patent Laid-Open No. 2001-281678.

In the first apparatus described above, the number of dropping points in the liquid crystal amount adjusting area at the center of display area is controlled. In the second apparatus, when the target value is large, the correction value is controlled by increasing or decreasing the number of dropping points of liquid crystal having a large dispensing amount per dropping point. In addition, when the correction value is small, the correction value is corrected by increasing or decreasing the number of dropping points of liquid crystal having a small dispensing amount. The overall dispensing amount of the liquid crystal material on the whole display area is thereby controlled closely.

When the column height of a column-shaped spacer can be manufactured uniformly and the dispensed liquid crystal material is uniformly spread over the whole display area, it is possible to properly correct a dispensing amount by the above methods. However, in practice, the column height cannot be made uniform in the display area and the dispensed liquid crystal material is not evenly distributed. Several percent to several tens percent of the dispensed liquid crystal remains near its dropped position. Therefore, degradation in display quality occurs due to mismatching between the column height of the column-shaped spacer and the dispensing amount of the liquid crystal material.

Specifically, in the first apparatus discussed above, when a measurement result of a column height is lower than the average value of the column spacers in the display area, it is necessary to decrease the total dispensing amount. Therefore, the number of dropping points in liquid crystal amount adjusting area is decreased. However, when the column height at the center of display area is the standard but the column height at the peripheral portion of display area is lower than it, such that the average height value of the overall display area is lower, the dispensed liquid crystal is not completely spread. Therefore, the amount of liquid crystal is decreased relative to the column height at the center of display area but increased in the peripheral portion of display area. In this case, the degradation in display quality occurs at the center of display area because more heavy load is applied to those column-shaped spacers. Moreover, the degradation in display quality occurs at the peripheral portion of display area due to the fact that excess liquid crystal material still remains.

### SUMMARY OF THE INVENTION

Therefore, an object of the invention is to provide a method and apparatus for manufacturing a liquid crystal display panel by improved one-drop fill process that is capable of suppressing degradation in display quality. It is a further purpose of the invention to provide such a method and apparatus with high-quality display characteristics.

Specifically, a method for manufacturing a liquid crystal display panel according to one aspect of the present invention, comprises measuring a height of a plurality of spacers at measuring points in plural virtual sectors divided in a display area of the substrate, correcting a dispensing amount of liquid crystal material for each virtual sector based on the measured height of the plurality of spacers within each virtual sector, dropping corrected dispensing amount of liquid crystal material at a plurality of dropping points on the substrate, and assembling the other substrate with the one substrate.

It is preferred that correcting the dispensing amount of liquid crystal material is performed by estimating the distribution of spacer heights in the display area, calculating an average value of the spacer heights in each virtual sector, and calculating the dispensing amount of liquid crystal material for each virtual sector based on difference between the average value of the spacer heights and a reference value of the spacer height.

It is preferred that estimating distribution of spacer heights in the display area is performed by interpolating column heights between the measuring points.

It is preferred that the spacer includes a column-shaped spacer. The term “column-shaped” as used therein embraces upstanding spacers of any shape, including cylindrical, parallelepiped and parallelepiped with rounded edges.

It is preferred that the correcting dispensing amount of liquid crystal material for each virtual sector is performed by correcting dispensing amount of each dropping point for each virtual sector relative to the difference between the average value of the measured spacer heights and a reference value of the spacer height.

It is preferred that the correcting dispensing amount of liquid crystal material for each virtual sector is performed by controlling the number of dropping points for each virtual sector based on difference between the average value of the measured spacer heights and a reference value of the spacer height.

It is preferred that the correcting dispensing amount of liquid crystal material for each virtual sector is performed by changing dropping points in one virtual sector based on difference between the average value of the measured spacer heights and a reference value of the spacer height.

It is preferred that the correcting dispensing amount of liquid crystal material for each virtual sector is performed by correcting dispensing amount of each dropping point for each virtual sector based on difference between the average value of the measured spacer heights and a reference value of the spacer height, and performed by controlling the number of dropping points in each virtual sector calculated from the difference between the average value of the measured spacer heights and a reference value of the spacer height.

Moreover, an apparatus for manufacturing a liquid crystal display panel of the present invention, comprises a spacer height measuring section for virtually dividing a display area into a plurality of sectors in one of the pair of substrates and measuring a height of the plurality of spacers at measuring points in the divided display area on which the plurality of spacers are formed, a dispensing amount calculating section for correcting dispensing amount of liquid crystal material calculated measured height of the plurality of spacers in each virtual sector, a liquid crystal material dispenser section for dropping liquid crystal material on a plurality of dropping points of one substrate based on corrected dispensing amount of liquid crystal material, and a substrate superimposing section for superimposing one substrate on the other substrate to stick the pair of substrates using sealing material.

It is preferred that correcting dispensing amount of liquid crystal material is performed by estimating distribution of spacer heights in the display area, calculating average value of the spacer heights in each virtual sector, and calculating the dispensing amount of liquid crystal material for each virtual sector calculated from the difference between the average value of the spacer heights and a reference value of the spacer height.

It is preferred that estimating distribution of spacer heights in the display area is performed by interpolating column heights between the measuring points.

It is preferred that wherein the spacer includes a column-shaped spacer.

It is preferred that wherein correcting dispensing amount of liquid crystal material for each virtual sector is performed by correcting dispensing amount of each dropping point for each virtual sector calculated from the difference between the average value of the measured spacer heights and a reference value of the spacer height.

It is preferred that correcting dispensing amount of liquid crystal material for each virtual sector is performed by controlling the number of dropping points for each virtual sector calculated from the difference between the average value of the measured spacer heights and a reference value of the spacer height.

It is preferred that correcting dispensing amount of liquid crystal material for each virtual sector is performed by changing dropping points in one virtual sector calculated from the difference between the average value of the measured spacer heights and a reference value of the spacer height.

It is preferred that correcting dispensing amount of liquid crystal material for each virtual sector is performed by correcting dispensing amount of each dropping point for each virtual sector calculated from the difference between the average value of the measured spacer heights and a reference value of the spacer height, and performed by controlling the number of dropping points for each virtual sector calculated from the difference between the average value of the measured spacer heights and a reference value of the spacer height.

According to the method for manufacturing a liquid crystal display panel of the present invention, an appropriate dispensing amount of liquid crystal material is dropped in the every virtual sector dropped to a proper dropping position. Therefore, it is possible to produce a uniform and high-quality display panel at a high throughput.

Moreover, according to the apparatus for manufacturing a liquid crystal display panel of the present invention, appropriate dispensing amount of liquid crystal material is dropped in every virtual sector and dropped to a proper dropping position. Therefore, it is possible to produce a uniform and high-quality display panel at a high throughput.

The dispensing amount of liquid crystal material can be controlled in each virtual sector of the display area in the liquid crystal display panel as below. Spacer heights are measured at a plurality of measuring points on the display area in a substrate, distribution of spacer heights in the display area is estimated in accordance with the measured spacer heights. The average value of the spacer heights are calculated in every virtual sector, and a dispensing amount in every sector is accurately controlled in accordance with the difference between the average value and the reference value. The control of the dispensing amount in ever sector is performed by correcting the dispensing amount of each dropping point for each virtual sector calculated from the difference between the average value of the measured spacer height and a reference value of the spacer height, or performed by controlling the number of dropping points for each virtual sector based on difference between the average value of the measured spacer height and a reference value of the spacer height.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a sectional view schematically showing a state of a liquid crystal display panel just before two substrates are stacked each other according to the liquid crystal dropping and sticking mode of the first exemplary embodiment of the present invention;

FIG. 2 is a flowchart showing a method for manufacturing a liquid crystal display panel according to the liquid crystal dropping and sticking mode of the first embodiment of the present invention;

FIG. 3 is an illustration showing measuring points of column heights of the CF substrate of the first embodiment of the present invention;

FIG. 4 is an illustration showing the distribution of column heights of the CF substrate of the first embodiment of the present invention and virtual sectors;

FIG. 5 is a flowchart showing the procedure of calculating the correction value of dispensing amount of the first embodiment of the present invention;

FIG. 6 is an illustration showing a state of dropping liquid crystal in the TFT substrate of the first exemplary embodiment of the present invention;

FIG. 7 is an illustration showing a state of dropping liquid crystal in the TFT substrate of the second exemplary embodiment of the present invention; and

FIG. 8 is a block diagram to explain an apparatus for manufacturing a liquid crystal display panel of the exemplary embodiments of the present invention.

### DETAILED DESCRIPTION OF THE PREFERRED EMBODIMENTS

Prior to explaining the preferred embodiments of the present invention, fundamental concept of the invention will be explained.

The present invention is a method and an apparatus for manufacturing liquid crystal display panel having the steps of dropping liquid crystal material on at least either one of a pair of substrates which alignment process has already performed to form an alignment film on the substrates, and superimposing the pair of the substrates to form a gap between the pair of substrates. Especially, The liquid crystal display panel manufacturing method has the steps of dropping liquid crystal material on at least either of a pair of substrates and superimposing the both substrates in a vacuum state and then releasing them into atmospheric air to form a gap filled by liquid crystal material. Spacer heights are measured at a plurality of measuring points on the display area of one substrate, and then the distribution of spacer heights on the display area is estimated in accordance with the measured heights. The average value of spacer heights is calculated in every virtual sector obtained by dividing the display area into a predetermined number. The dispensing amount of the liquid crystal to be dropped on each of the sectors is corrected in accordance with the difference between the average value of spacer heights and a preset reference value. The dropping position of the liquid crystal is adjusted in accordance with the difference between average values of spacer heights of each sector. The liquid crystal is dropped on the substrate in accordance with the dispensing amount or dropping position in every sector.

Thereby, when there is a fluctuation in spacer heights in the display area, it is possible to drop a proper amount of liquid crystal material for every sector or drop the liquid crystal material to a proper position. Therefore, it is possible to manufacture a liquid crystal display panel capable of suppressing degradation in display quality and having high quality.

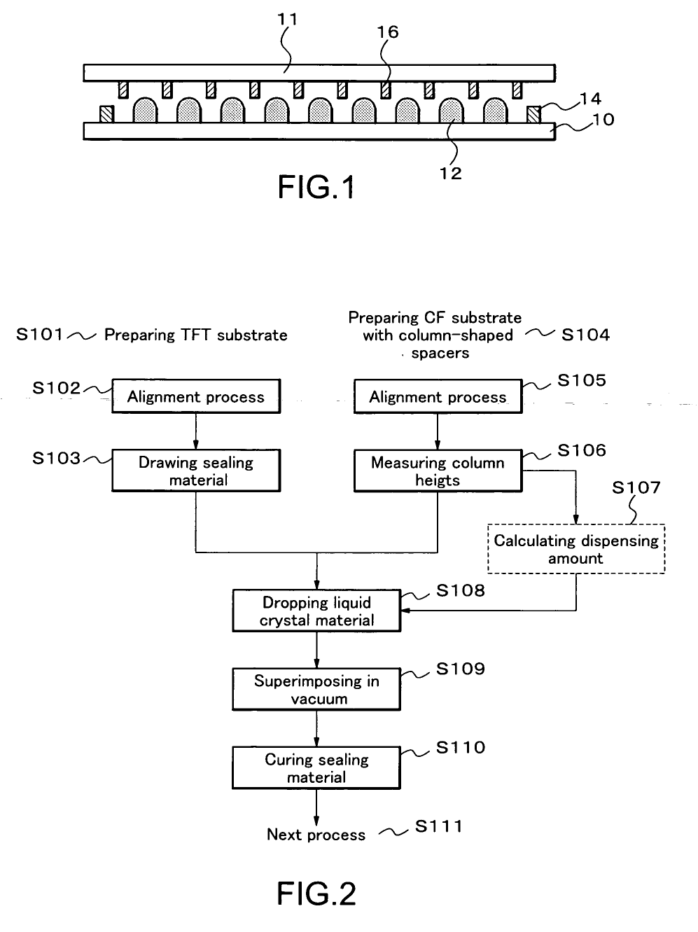

A method and an apparatus for manufacturing a liquid crystal display panel of the first exemplarily embodiment of the invention are described below by referring to FIGS. 1 to 6 and 8.

As shown in FIG. 1, the liquid crystal display panel of this embodiment is constituted of an active matrix substrate, a counter substrate and a liquid crystal layer. As an example of the active matrix substrate, TFT substrate 10 in which switching devices such as thin film transistors (TFTs) are formed in a matrix is used. As an example of the counter substrate, CF substrate 11 in which a color filter (CF) and a black matrix (BM) and the like are formed is used. The liquid crystal layer comprises the liquid crystal material 12 that is sandwiched between TFT substrate 10 and CF substrate 11 in which sealing material 14 for sticking two substrates is drawn on the TFT substrate 10. As an example of a spacer keeping a cell gap between TFT substrate 10 and CF substrate 11, column-shaped spacers 16 are provided on the CF substrate 11.

This embodiment uses a technique of virtually dividing display area into a plurality of sectors (hereafter referred to as virtual sectors) instead of determining the dispensing amount of the liquid crystal material to the whole display area. Control of the dispensing amount is performed for each virtual sector. Specifically, column heights of column-shaped spacers are measured at a plurality of measuring points on the display area, the distribution of the column heights is estimated in accordance with the measurement result of them. The average value of column heights in each virtual sector is calculated in accordance with the distribution, the difference between the average value and a preset reference value is calculated. The dispensing amount for each virtual sector is calculated in accordance with the difference.

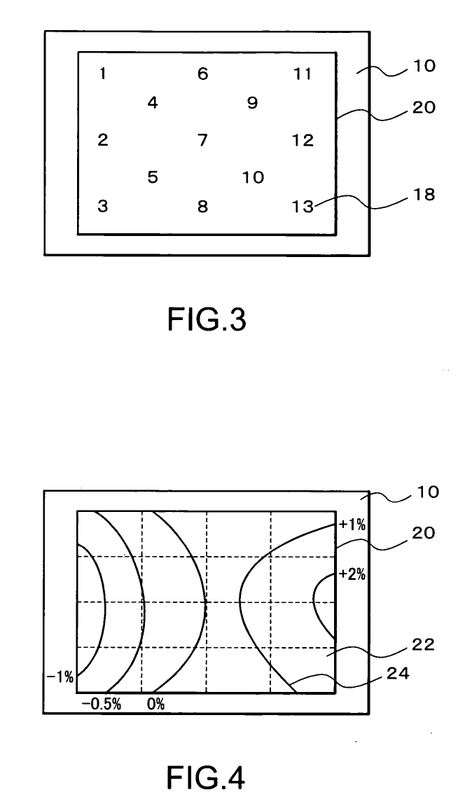

In this case, it is enough that the number of measuring points for the column-shaped spacers is two or more. The positions of the measuring points are not limited. However, it is preferred to select measuring points at which calculation in accordance with the interpolation method can be performed when estimating the distribution of column heights. For example, as shown in FIG. 3, it is possible to use a configuration of measuring column heights at thirteen points in display area 20. It is unnecessary to apply the same number of measuring points to all substrates. For example, it is also allowed to calculate dispensing amount by measuring thirteen points at a frequency of once for ten substrates, measuring only three points among the thirteen points for remaining nine substrates. It is also allowed to calculate dispensing amount by correcting the whole column height in accordance with the difference between measurement results of the same measuring point.

Moreover, though a method of estimating the distribution of column heights in display area 20 in accordance with a measurement result of column heights is not limited, it is possible to estimate a distribution by obtaining column heights between measuring points from measured column heights using, for example, the response surface methodology. Referring to FIG. 4, the distribution of estimated column heights by the above method is shown by contour lines 24. It shows what percent the column heights of each contour line 24 is deviated from a reference column height. Moreover, virtual sectors 22 when display area 20 is divided into sixteen portions are shown by dotted lines. Though the number of divisions is not limited, it is preferred to at least divide into nine portions, such as a center, four corners, and four peripheries of display area 20.

Thus, by virtually dividing the display area 20 into a plurality of virtual sectors 22, in the case of virtual sector 22 at the top right corner of display area 20 in FIG. 4, it is possible to easily calculate that the average column height in the sector becomes approx. 1% higher than a reference column height. The dispensing amount of virtual sector 22 is calculated in accordance with the difference between the average column height and the reference column height. Moreover, shift values of average column heights for all virtual sectors 22 are similarly calculated and the correction value of the dispensing amount for each virtual sector 22 is calculated.

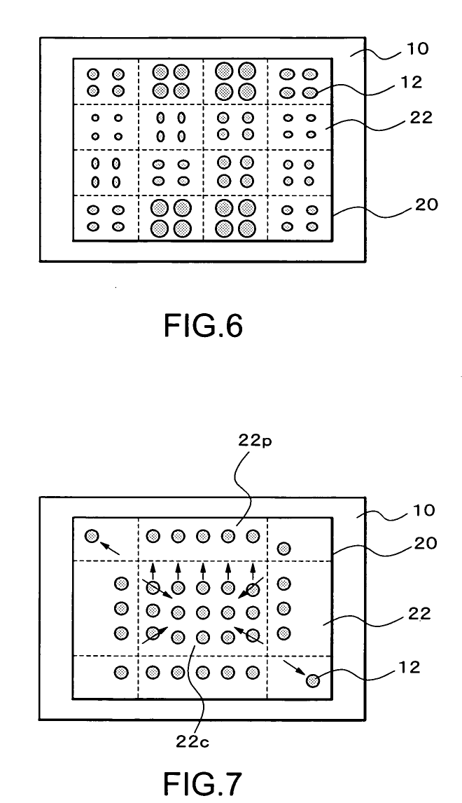

Referring to FIG. 6, it shows an after-dropping state in which liquid crystal material 12 is dropped at a calculated dispensing amount. In this case, the number of dropping points of liquid crystal material 12 for each virtual sector 22 is four. The dispensing amount at the four dropping points are the same as each other. That is, the dispensing amount for each virtual sector 22 is equally divided by four dropping points and dropped. For example, the previously-described virtual sector 22 at the top right corner of display area 20 becomes approx. 1% higher than a reference column height. Therefore, it is sufficient to drop liquid crystal material in an amount 1% greater than a previously-entered dispensing amount. The dispensing amount is corrected for all virtual sectors 22 in accordance with the same technique. The number of dropping points of liquid crystal material 12 to be dropped to each virtual sector 22 is not limited. When the number of virtual sector increases, it is allowed to decrease the number of dropping points of each virtual sector 22. Moreover, when the number of virtual sectors decreases, it is allowed to increase the number of dropping points for each virtual sector 22.

Thus, by virtually dividing the display area 20 into a plurality of virtual sectors 22, it is possible to accurately correct dispensing amount against the column height fluctuation in display area 20 compared to a method of correcting the total dispensing amount in whole display area 20 as proposed in the first and second related arts. Moreover, dropped liquid crystal material 12 is not completely and uniformly spread even for atmospheric air release after interposing two substrates in a vacuum. An advantage of suppressing degradation in display quality due to the difference between column height and liquid crystal amount can be obtained by the embodiment of the present invention.

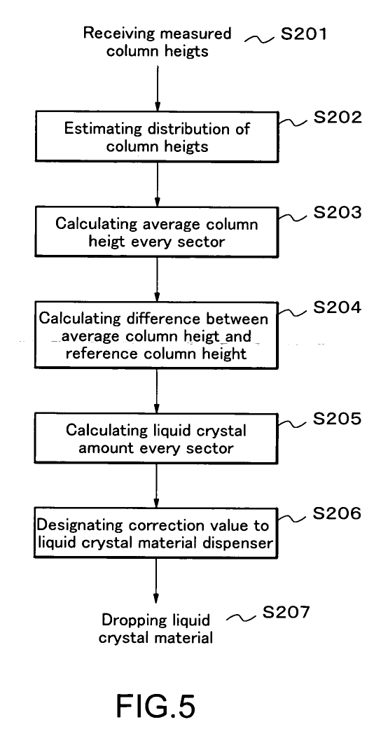

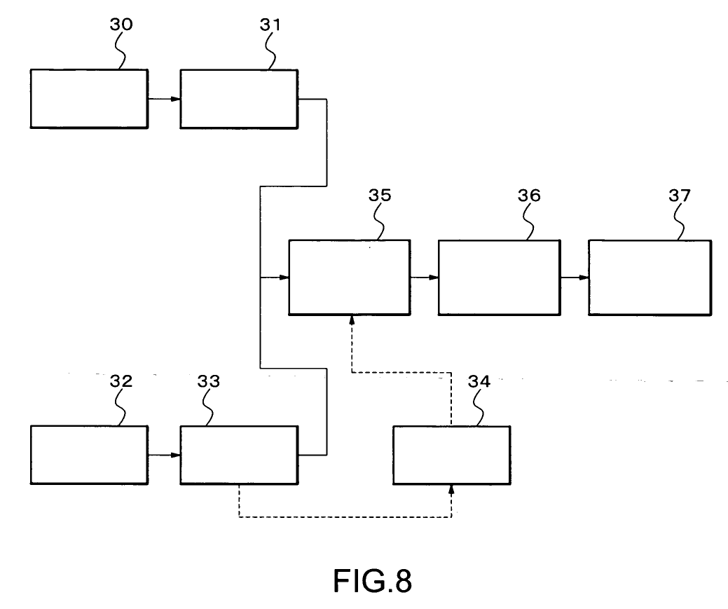

Then, the method for manufacturing a liquid crystal display panel of this embodiment is described below by referring to FIGS. 2 and 5. The method for manufacturing a liquid crystal display panel of the embodiment is performed by using an apparatus for manufacturing a liquid crystal display panel having a first alignment processing section 30, a sealing material drawing section 31, a second alignment processing section 32, a column height measuring section 33, a dispensing amount calculating section 34, a liquid crystal material dispenser section 35, a substrate superimposing section 36 and a sealing material curing section 37, as shown in FIG. 8. The arrows by solid lines show the direction of sequentially transferring a TFT substrate 10, a CF substrate 11 or a liquid crystal display panel. The arrows by dotted lines show the direction sequentially of signal or data used in the apparatus for manufacturing the liquid crystal display panel.

First, as shown in FIG. 2, TFT substrate 10 on which TFT patterns are formed and CF substrate 11 on which column-shaped spacers 16 are formed are prepared (S101 and S104). The TFT substrate 10 and the CF substrate 11 are transferred to the alignment processing sections 30 and 32 to conduct an alignment process such as rubbing process to alignment films, followed by forming of the alignment films on both TFT substrate 10 and CF substrate 11 (S102 and S105). Then, after the TFT substrate 10 is transferred to the sealing material drawing section 31, sealing material 14 applied and drawn to the TFT substrate 10 in such a manner as to surround a display area of the TFT substrate 10 (S103).

Then, after the CF substrate 11 is transferred to the column height measuring section 33, the column heights of column-shaped spacers 16 formed on CF substrate 11 are measured (S106). Publicly-known means such as mechanical contact system or non-contact system using a laser beam can be used for the measuring section 33. Moreover, it is preferred to set measuring points so that whole display area 20 is covered in order to improve the accuracy for calculating dispensing amount as shown in FIG. 3. In addition, it is preferred to set measuring points so that calculation in accordance with the interpolation method can be performed in order to improve the accuracy for calculating dispensing amount.

Then, the dispensing amount of liquid crystal material 12 is calculated in accordance with the measured column heights using dispensing amount calculating section 34 (S107). The dropping-amount calculating method uses the technique as shown in FIG. 5. Firstly, the distribution of column heights in the display area is estimated (S202), followed by receiving the result of the measured column heights (S201). An estimating technique uses a technique for interpolating column heights between measuring points by using the response surface methodology as described above. FIG. 4 shows the column height distribution thus estimated by contour lines. In the drawing, the percentage shown at an end of contour line 24 shows what percent is shifted to the reference column height by entering a designed value of a column height as a reference column height. For example, when assuming the reference height as 4.0 μm, an area enclosed by contour lines of −1% and −0.5% represents an area which is 0.04 to 0.02 μm lower than the reference column height.

Then, an area in display area 20 is virtually divided into a plurality of virtual sectors 22. FIG. 4 is an illustration showing that an area is divided into sixteen sectors and dotted lines shows boundaries between virtual sectors 22. Moreover, the average column height in each virtual sector 22 is calculated from the distribution of column heights in display area 20 (S203). The difference between the average column height and the above reference column height is calculated in each virtual sector 22 (S204). For example, in the case of virtual sector 22 at the top right corner of display area 20 in FIG. 4, an area of 0 to +1% and an area of +1 to +2% respectively occupy a half portion. Therefore, it is possible to calculate that the difference between the average column height in virtual sector 22 and the reference column height is approx. +1%. Actual calculation is further strictly performed. Similarly, the difference between the average column height and the reference column height is calculated for all virtual sectors.

Then, the correction value of dispensing amount is calculated in accordance with the calculated difference between column heights in each virtual sector 22 (S205). The correction value is designated to a liquid crystal dispenser section 35 (S206). After the TFT substrate 10 is transferred to the liquid crystal material dispenser section 35, the liquid crystal dispenser drops an appropriate liquid crystal material 12 of designated dispensing amount (S207). FIG. 6 is an illustration showing a state immediately after liquid crystal material 12 of corrected dispensing amount is dropped to TFT substrate 10. As shown in FIG. 6, the correction of dispensing amount is executed for each virtual sector 22. The dispensing amount dropped is previously entered for the case of reference column height. For example, in the case of virtual sector 22 at the top right corner of display area 20, the average column height is approx. 1% higher than the reference column height. Therefore, the dispensing amount in virtual sector. 22 is increased by approx. 1% larger than the reference dispensing amount. Hereafter, dispensing amount is corrected to similarly designated dispensing amount to execute dropping for next virtual sector 22.

Dropping mode of the liquid crystal dispenser can be selected freely and it is not limited. However, it is preferred to set ±0.5% or less to a purposed value as the accuracy of dispensing amount. Moreover, the conformation of an apparatus for executing the process between steps S202 and S206 is not limited. It is enough that means for executing the above processes or a control unit for executing the above processes is included in, for example, the column height measuring section 33 or the liquid crystal material dispenser section 35. In other word, it is enough that means for executing the above processes is equipped with the apparatus for manufacturing liquid crystal display panel.

After the TFT substrate 10 is transferred to the liquid crystal material dispenser section 35, the liquid crystal dispenser drops liquid crystal material 12 to the TFT substrate 10 (S108). The TFT substrate 10 is conveyed into a chamber of the substrate superimposing section 36. The CF substrate 11 is superimposed on the TFT substrate 10 in a vacuum state (S109). Thereafter, by releasing the chamber to atmospheric air, CF substrate 11 and TFT substrate 10 are stacked due to the pressure difference between vacuum states inside the substrates and the atmospheric air outside the substrates, liquid crystal material 12 present between the substrates expands and thereby, a gap is formed between the substrates. Then, the stacked substrates 10 and 11 are transferred to the sealing material curing section 37. By performing ultraviolet (UV) ray irradiation and heat treatment, sealing material 14 is cured to obtain a liquid crystal display panel (S110). The manufactured liquid crystal display panel is transferred to next manufacturing process (S111).

Thus, this embodiment uses a technique of correcting dispensing amount for each virtual sector 22 by considering the column height in whole display area 20 when calculating the correction value of dispensing amount. Therefore, it is possible to accurately control the relation between column height of a manufactured liquid crystal display panel and dispensing amount of liquid crystal material. Therefore, it is possible to obtain a liquid crystal display panel having a characteristic of very uniform display quality and decrease defects involved therein. Moreover, it is possible to manufacture a liquid crystal display panel having a high-quality display characteristic.

Then, a method for manufacturing a liquid crystal display panel of second exemplary embodiment of the present invention are described by referring to FIG. 7. In the case of the above described first exemplary embodiment, the dispensing amount is corrected for each virtual sector 22 in accordance with the difference between the average column height in each virtual sector 22 and the preset reference column height. However, also by changing dropping position, an effect same as the case when changing dropping quantities can be obtained. Moreover, the same construction as the first exemplary embodiment can be used for the apparatus for manufacturing a liquid crystal display panel of the embodiment. In the case of this embodiment, similarly to the case of the first exemplary embodiment, processes between steps S201 to S203 are performed. Moreover, dropping position is moved so that more liquid crystal material 12 is distributed by virtual sector 22 having a large average column height in accordance with the average column height in each virtual sector 22.

Specifically, as shown in FIG. 7, the inside of display area 20 is divided into a plurality of virtual sectors 22. In this case, the inside of display area 20 is divided into nine virtual sectors 22. Then, operation is performed similarly to the case of the first exemplary embodiment until the average column height in each virtual sector 22 is calculated (S203). Then, dispensing amount is calculated and determined by comparing the average column height of the whole display area with the reference column height. Therefore, the dispensing amount becomes constant at each dropping point of each virtual sector 22.

Up to here, the column height distribution in display area 20 is not considered similarly to the case of the first and second related arts and degradation in display quality may occur. Therefore, in the case of this embodiment, a dropping position is moved in a virtual sector. When the column height of central virtual sector 22c of display area 20 is higher than those of other virtual sectors 22, dropping positions are moved near center as shown by arrows toward a central portion of the virtual sector 22c in FIG. 7. When the CF substrate 11 is superimposed to the TFT substrate 10, dropped liquid crystal material 12 is spread toward peripheral directions and thereby a space between the two substrates are filled up with the liquid crystal material 12. In case of dropping the liquid crystal material 12 near a boundary between adjacent virtual sectors 22 on the TFT substrate 10, when the CF substrate 11 is superimposed to the TFT substrate 10, some amount of the dropped liquid crystal material 12 will spread to adjacent virtual sectors 22 by traversing the boundary. When a dropping point is moved toward a central portion of the virtual sector 22c in the virtual sector 22c, many part of dropped liquid crystal material 12 in the virtual sector 22c remains in the virtual sector 22c. Because as described above, dropped liquid crystal material 12 is not completely and uniformly spread. Therefore, after CF substrate 11 is superimposed to TFT substrate 10, much liquid crystal material 12 remains at the central portion of display area 20. Therefore, liquid crystal amount spread to an adjacent virtual sector 22 from the central virtual sector 22c is decreased. As the result of moving the dropping point in a virtual sector, an effect same as the case of increasing the dispensing amount at the central portion is obtained.

When the column height of the central virtual sector 22c is lower than those of other virtual sectors 22, it is enough dropping positions are moved near periphery in the central virtual sector 22c as shown by arrows toward peripheral virtual sector 22p in FIG. 7. When a dropping point is moved toward the peripheral portion of the virtual sector 22c in the virtual sector 22c, liquid crystal amount spread to an adjacent virtual sector 22p is increased. Therefore, after CF substrate 11 is superimposed to TFT substrate 10, liquid crystal amount spread to an adjacent virtual sector 22p is increased and remaining liquid crystal amount in the central virtual sector 22c is decreased. As the result of moving the dropping point in a virtual sector, an effect same as the case decreasing the dispensing amount at the central portion is obtained. In case of moving the dropping point described above, more liquid crystal material 12 is distributed in the peripheral virtual sector 22p having a large average column height. Therefore, appropriate amount of the liquid crystal material 12 is distributed by virtual sector 22 in accordance with the average column height in each virtual sector 22.

Moreover, it is allowed to set the moving distance and moving direction of a dropping point in accordance with the degree of the difference of column heights for each virtual sector 22. Thus, in the case of this embodiment, a technique of moving dropping positions in each virtual sector 22 is used by considering the column height in each virtual sector 22. Therefore, it is possible to accurately control the relation between column height of a manufactured liquid crystal display panel and liquid crystal amount. Therefore, similarly to the case of the first exemplary embodiment, it is possible to realize a very uniform and high display quality liquid crystal display panel and the number of defects involved therein can be decreased. Therefore, it is possible to manufacture a liquid crystal display panel having a low manufacturing cost and a high-quality display characteristic.

In the case of the above first exemplary embodiment, the dispensing amount is corrected for each virtual sector 22. In the case of the above second exemplary embodiment, the dropping position is adjusted. However, it is allowed to combine the first exemplary embodiment with the second exemplary embodiment. In this case, it is also allowed to greatly correct dispensing amount by the method of the first exemplary embodiment and fine adjust the dispensing amount by the method of the second exemplary embodiment.

Although the exemplary embodiments have been described above, the present invention is not limited thereto but various changes and applications are possible. Each of the above exemplary embodiments is constituted so as to form column-shaped spacers 16 on CF substrate 11, draw sealing material 14 on TFT substrate 10, and drop liquid crystal material 12. However, the present invention is not limited to the above embodiments. The present invention can be modified so as to form column-shaped spacers 16 on TFT substrate 10 or on both CF substrate 11 and TFT substrate 10. The present invention can be modified so as to draw sealing material 14 on CF substrate 11 or on both CF substrate 11 and TFT substrate 10. Moreover, the present invention can be modified so as to drop liquid crystal material 12 to CF substrate 11. Moreover, in the case of each of the above embodiments, a method of the present invention is applied to a mode of dropping liquid crystal material in a vacuum state, sticking two substrates and returning the vacuum state to the atmospheric pressure, and curing a sealing material (vacuum dropping and sticking mode). However, the method of the present invention can be similarly applied to a mode of dropping liquid crystal material in an atmospheric air, sticking two substrates, and curing a sealing material by applying pressure between substrates (normal-pressure dropping and sticking mode).

Furthermore, in the exemplary embodiments described above, a CF substrate is utilized for the counter substrate. However, the present invention can be applied to such liquid crystal display panels in which color filter layer is formed on an active matrix substrate, such as liquid crystal display panel of Color filter On TFT (COT) type. In addition, the present invention can be applied to such monochromatic type liquid crystal display panels in which a color filter is not formed on both an active matrix substrate and a counter substrate.

Although preferred embodiments of the invention have been described with reference to the drawings, it will be obvious to those skilled in the art that various changes or modifications may be made without departing from the true scope of the invention.

What is claimed is:

1. A method for manufacturing a liquid crystal display panel having a pair of substrates and liquid crystal material sandwiched between the pair of substrates, by a one-drop fill process, comprising:
measuring a height of a plurality of spacers at measuring points in plural virtual sectors of a display area of one of the pair of substrates;
correcting a dispensing amount of liquid crystal material for each virtual sector based on the measured height of the plurality of spacers within each virtual sector;
dropping liquid crystal material at a plurality of dropping points on the one substrate based on a corrected dispensing amount of liquid crystal material; and
superimposing the other substrate on the one substrate to assemble the pair of substrates.

2. The method for manufacturing a liquid crystal display panel according to claim 1,
wherein correcting a dispensing amount of liquid crystal material is performed by estimating a distribution of spacer heights in the display area, calculating an average value of the spacer heights in each virtual sector, and calculating the dispensing amount of liquid crystal material for each virtual sector based on a difference between the average value of the spacer heights and a reference value of the spacer height.

3. The method for manufacturing a liquid crystal display panel according to claim 2,
wherein estimating a distribution of spacer heights in the display area is performed by interpolating column heights between the measuring points.

4. The method for manufacturing a liquid crystal display panel according to claim 1,
wherein the plurality of spacers includes column-shaped spacers.

5. The method for manufacturing a liquid crystal display panel according to claim 1,
wherein correcting a dispensing amount of liquid crystal material for each virtual sector is performed by correcting a dispensing amount of each dropping point for each virtual sector based on a difference between the average value of the measured spacer heights and a reference value of the spacer height.

6. The method for manufacturing a liquid crystal display panel according to claim 1,
wherein correcting a dispensing amount of liquid crystal material for each virtual sector is performed by increasing or decreasing the number of dropping points for each virtual sector based on a difference between the average value of the measured spacer heights and a reference value of the spacer height.

7. The method for manufacturing a liquid crystal display panel according to claim 6,
wherein correcting a dispensing amount of liquid crystal material for each virtual sector is performed by moving dropping points in one virtual sector based on a difference between the average value of the measured spacer heights and a reference value of the spacer height.

8. The method for manufacturing a liquid crystal display panel according to claim 1,
wherein correcting a dispensing amount of liquid crystal material for each virtual sector is performed by correcting a dispensing amount of each dropping point for each virtual sector based on a difference between the average value of the measured spacer heights and a reference value of the spacer height, and if further performed by increasing or decreasing the number of dropping points for each virtual sector based on a difference between the average value of the measured spacer heights and a reference value of the spacer height.

9. An apparatus for manufacturing a liquid crystal display panel having a pair of substrates and liquid crystal material sandwiched between the pair of substrates, comprising:
a spacer height measuring section for virtually dividing a display area of one of the pair of substrates into a plurality of virtual sectors and measuring a height of the plurality of spacers at measuring points in a display area of the substrate on which the plurality of spacers are formed;
a dispensing amount calculating section for correcting dispensing amount of liquid crystal material based on measured height of the plurality of spacers in each virtual sector;
a liquid crystal material-dispenser section for dropping liquid crystal material on a plurality of dropping points on one substrate based on corrected dispensing amount of liquid crystal material; and
a substrate superimposing section for superimposing the other substrate on the one substrate to assemble the pair of substrates.

10. The apparatus for manufacturing a liquid crystal display panel according to claim 9,
wherein the dispensing amount calculating section corrects a dispensing amount of liquid crystal material by estimating a distribution of spacer heights in the display area, calculating an average value of the spacer heights in each virtual sector, and calculating the dispensing amount of liquid crystal material for each virtual sector based on difference between the average value of the spacer heights and a reference value of the spacer height.

11. The apparatus for manufacturing a liquid crystal display panel according to claim 10,
wherein the dispensing amount calculating section estimates a distribution of spacer heights in the display area by interpolating column heights between the measuring points.

12. The apparatus for manufacturing a liquid crystal display panel according to claim 10,
wherein the plurality of spacers includes column-shaped spacers.

13. The apparatus for manufacturing a liquid crystal display panel according to claim 9,
wherein the dispensing amount calculating section corrects a dispensing amount of liquid crystal material for each virtual sector by correcting a dispensing amount of each dropping point for each virtual sector based on a difference between the average value of the measured spacer heights and a reference value of the spacer height.

14. The apparatus for manufacturing a liquid crystal display panel according to claim 9,
wherein the dispensing amount calculating section corrects a dispensing amount of liquid crystal material for each virtual sector by increasing or decreasing the number of dropping points for each virtual sector based on a difference between the average value of the measured spacer heights and a reference value of the spacer height.

15. The apparatus for manufacturing a liquid crystal display panel according to claim 14,
wherein the dispensing amount calculating section corrects a dispensing amount of liquid crystal material for each virtual sector by moving dropping points in one virtual sector based on a difference between the average value of the measured spacer heights and a reference value of the spacer height.

16. The apparatus for manufacturing a liquid crystal display panel according to claim 9,
wherein the dispensing amount calculating section corrects a dispensing amount of liquid crystal material for each virtual sector by correcting a dispensing amount of each dropping point for each virtual sector based on a difference between the average value of the measured spacer heights and a reference value of the spacer height, and by increasing or decreasing the number of dropping points for each virtual sector based on a difference between the average value of the measured spacer heights and a reference value of the spacer height.
